(19) United States
(12) Patent Application Publication
(10) Pub. No.: US 2008/0196315 A1
(43) Pub. Date: Aug. 21, 2008

(54) DOOR EDGE PROTECTORS FOR USE IN CONJUNCTION WITH A DOOR PROTECTIVE COVER

(76) Inventors: Michael B. Brisbois, Littleton, CO (US); Richard A. Brisbois, Plano, TX (US)

Correspondence Address: Leyendecker & Lemire, LLC, C/O PORTFOLIO IP, P.O. BOX 52050, MINNEAPOLIS, MN, 55402, US

(21) Appl. No.: 12/058,093

(22) Filed: Mar. 28, 2008

Related U.S. Application Data
(63) Continuation-in-part of application No. 11/566,096, filed on Dec. 1, 2006.

(51) Int. Cl. E06B 3/88; E04B 1/62

(52) U.S. Cl. 49/462; 52/741.3

(57) ABSTRACT

Embodiments of door edge protective covers that protect a door's edge surfaces are described that are adapted to be used in conjunction with door protective covers that protect the door's face surfaces.

### REFERENCE TO RELATED APPLICATIONS

This application is related to: (i) U.S. patent application Ser. No. 11/566,096 filed on May 30, 2007 and (ii) U.S. patent application Ser. No. ______ filed on ______, 2008, both entitled Door Protective Cover and having at least one common inventor with the present application. The foregoing applications are incorporated herein in their entirety by reference.

### FIELD OF THE INVENTION

The present invention pertains generally to coverings for protecting doors from damage.

### BACKGROUND

The substantially planer front and rear surfaces and the edge surfaces spanning therebetween of interior and exterior doors of offices, other commercial buildings and even residences are vulnerable to damage during movement and installation, construction, remodeling and painting. For instance, in an office environment undergoing interior construction followed by the move in of new tenants, the associated doors can be at risk of damage for extended periods of time from a few days to several weeks or months.

It is known to cover doors with blankets that may or may not be padded. However, blankets hung over a door are often too short to protect an entire side thereof and are prone to sliding off of the door. Further, blankets are often not suitable for covering the edge surfaces. For instance, they may not be wide enough; and they may not stay in place without being pinned, clamped or taped. Pinning, clamping or taping a blanket in place is time consuming and will often not be performed. Depending on how a blanket is folded over a door and around the edge surfaces, the ability of the door to open and close may be compromised.

Several door protectors are known in the art including those taught in U.S. Pat. Nos. 5,255,727 ('727); 4,372,364 ('364); 5,351,733 ('733); and 6,029,409 ('409). The cover taught in the '727 patent is comprised of a fabric material that typically includes an interior panel or padding layer. Velcro material is provided to secure the cover in place on a door including much of the door's edge surfaces.

The door protective device of U.S. Pat. No. 5,351,733 is typically comprised of a padded cloth material and includes several elastic and fabric straps. Further, the padded cloth material taught in this patent is unlikely to provide much impact protection save for very light incidental impacts.

The door protector taught in the U.S. Pat. No. 4,372,364 is also made of a cloth material and typically includes cotton padding to provide some impact protection. Velcro material is also sewn to the protector. Given the protector's construction and its inherent cost of fabrication, it is not considered disposable and therefore must be stored when not in use. The '364 protector only covers a single side of a door and is therefore not suitable in environments where the door may be damaged on the uncovered back side or on its side surfaces.

The doorway shield taught in U.S. Pat. No. 6,029,409 is also designed to cover only a single side of an associated door. Additionally, the '409 shield covers the hinged interface and adjacent door jamb. The sheet material comprising the shield is preferably semi-rigid but resilient permitting bending to hook over the door. The preferred sheet material comprises 20-30 mil thick polyethylene sheeting backed by ⅙-¼″ thick polyethylene foam. The thickness of the sheet and foam along with the shield's configuration are necessary for the proper operation of the shield as taught in the '409 patent; however, its thickness also prevents it from being foldable for storage and transport. Additionally, like the cover of the '364 patent, the '409 shield both only protects a single side of a door and covers the door handle.

### BRIEF DESCRIPTION OF THE DRAWINGS

FIG. 1 is a front view of a corrugated cardboard sheet including thereon a plurality of nicks, knifes and perforations to effective form multiple sets of door edge protectors according to an embodiment of the present invention.

FIG. 2A is a front view of a strike side edge protector prior to folding or installation according to an embodiment of the present invention.

FIG. 2B is an isometric view of the strike side edge protector illustrating the protector as it is bent and configured when being utilized in conjunction with a door protector on a door according to an embodiment of the present invention (the door and door protector are not illustrated in this view for clarity).

FIG. 2C is an isometric view of a strike side edge protector in its folded or storage configuration according to an embodiment of the present invention.

FIG. 3A is a front view of a hinge side edge protector prior to folding or installation according to an embodiment of the present invention.

FIG. 3B is an isometric view of the hinge edge protector illustrating the protector as it is bent and configured when being utilized in conjunction with a door protector on a door according to an embodiment of the present invention (the door and door protector are not illustrated in this view for clarity).

FIG. 3C is an isometric view of a hinge side edge protector in its folded or storage configuration according to an embodiment of the present invention.

FIG. 4A is a front view of a panel of door protective cover with which the set of door edge protectors can be utilized according to one embodiment of the present invention.

FIG. 4B is an isometric view of the door protective cover of FIG. 4a illustrating the cover in a folded configuration according to the embodiment of the present invention.

FIG. 5 is cross sectional view of a door protective cover taken along line 5-5 of FIG. 4a and a set of edge protectors installed on a door according to one embodiment of the present invention (of note: the door is illustrated separate from the door frame for clarity although in many instances the door will be installed in a frame when the door protective cover and set of edge protectors are utilized).

FIG. 6A is a partial isometric view of a strike side protector installed on a door according to one embodiment of the present invention shown without the door protector for clarity.

FIG. 6B is a partial isometric view of a hinge side protector installed on a door according to one embodiment of the present invention shown without the door protector for clarity.

FIG. 7 is a flow chart illustrating the installation of a door protector and an associated set of edge protectors on a door according to one embodiment of the present invention.

FIG. 8 is a front view of a corrugated cardboard sheet including thereon a plurality of nicks, knifes and perforations to effective form multiple sets of door edge protectors according to a second embodiment of the present invention.

FIG. 9 is a front view of a strike side edge protector prior to folding or installation according to a second embodiment of the present invention.

### DETAILED DESCRIPTION

Embodiments of the present invention comprise relatively inexpensive, foldable door edge protective covers that are intended to be used in conjunction with door protective covers as described in U.S. patent application Ser. Nos. 11/566,096 & ______ as have been incorporated herein by reference.

As described in the referenced patent applications, the door protective cover provides impact and surface protection of both sides of an associated hung and installed door. Various embodiments of the door protective covers can be used to protect a door in shipment and prior to being hung as well. Embodiments of the door protective cover, however, offer limited protection to the vertical side edges of a door. In many instances the risk of damage to these vertical edges that span between the front and rear sides of a door is relatively small due at least in part to the relative narrow widths of the edges; however, in certain circumstances protecting these edges is desirable.

Embodiments of the present invention comprise a set of edge protective covers that substantially cover and protect the vertical edges of a door that has a door protective cover installed thereon.

At least one embodiment comprises a set of two of elongated corrugated cardboard pieces designed to integrate with various embodiments of the door protective cover. A first piece of the set is configured to protect the strike side vertical edge, and a second piece is configured to protect the hinge side vertical edge. As applicable, the edge protective cover include one or two elongated lengthwise fold lines delineating between portions of the cover that actually cover a vertical edge and the portions that are typically received underneath the respective and corresponding edges of the door protective cover.

Embodiments of the edge protectors can be secured in place by any suitable means but typically the edge tape or edge strips of the associated door protector are utilized. In one embodiment, the outside surface of the edge protectors includes pieces of hook and/or loop material secured thereto. The location of the pieces of hook and/or loop material correspond to the location of hook and/or loop edge straps on the panels of the door protector. When the edge strap is placed over the piece of material on the edge protector, it adheres to it. Accordingly, the edge strap of the corresponding door protector not only secures the front and back panels of the door protector together but also acts to secure the associated edge protector in place as well.

In various embodiments, the portions of the edge protectors that are typically received under a door protector can include a plurality of perforations in strategic locations that can be removed as necessary as not to interfere with door hardware located on the front or back surfaces of a door, such as a door knob pull or lever handle and/or a security latch bar or chain. The perforations typically correspond to similar perforations provided on an associated door protective cover.

Also, at least some embodiments of the edge protectors include one or more widthwise creases or folds that permit the edge protectors to folded for storage or transport in a manner much similar to the associated door protective cover. Embodiments can for storage convenience often be slid between panel sections of a folded door protective cover thereby permitting the entire door protective system to be kept together.

### Terminology:

The terms and phrases as indicated in quotes (“ ”) in this section are intended to have the meaning ascribed to them in this Terminology section applied to them throughout this document including the claims unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive rather the term is inclusive meaning “either or both”.

References in the specification to “one embodiment”, “an embodiment”, “a preferred embodiment”, “an alternative embodiment” and similar phrases mean that a particular feature, structure, or characteristic described in connection with the embodiment is included in at least an embodiment of the invention. The appearances of the phrase “in one embodiment” in various places in the specification are not necessarily all meant to refer to the same embodiment.

The term “couple” or “coupled” as used in this specification and the appended claims refers to either an indirect or direct connection between the identified elements, components or objects. Often the manner of the coupling will be related specifically to the manner in which the two coupled elements interact.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

As applicable, the terms “about” or “generally” as used herein unless otherwise indicated means a margin of +−20%. Also, as applicable, the term “substantially” as used herein unless otherwise indicated means a margin of +−10%. It is to be appreciated that not all uses of the above terms are quantifiable such that the referenced ranges can be applied.

The terms “Saddle”, Saddle Tape” and “Saddle Element” as used herein refer to the portion of the door protector that is adapted to be hung over the top horizontal edge of an associated door off of which the front and back panels of the protector typically hang. For instance, depending on the embodiment and variation, the Saddle Element(s) can comprise thin flexible plastic sheet material, woven or non-woven fabric, paper and/or straps. The Saddle Element(s) can include portions with adhesive applied thereto to secure it to the corrugated cardboard sheets or in other variations it can comprise a hook or loop material with corresponding hook and loop material also being applied to the corrugated cardboard sheets proximate their top edges.

The term “Edge Tape” as used herein refers to pieces of tape used to secure the front and back panels of the door protector together along the vertically extending edges thereof. The edge tape can comprise a pressure sensitive adhesive on one side thereof but only proximate the ends thereof so that no adhesive (or only a minimal amount of adhesive) comes in contact with the sides of an associated door but the tape can firmly affix to the surfaces of the front and rear panels of the door protector. Like the Saddle Element(s), the Edge Tape can also, but not necessarily, comprise thin flexible plastic sheet material, woven or non-woven fabric, paper and/or straps. Also, in some variations in place of the Edge Tape, a hook and loop material can be utilized.

The term “Fiberboard” refers to a generally rigid or semi-rigid sheet material that is comprised primarily of wood or paper fibers. Paper fiberboard as the name suggests is comprised primarily of paper fibers. Typically, although not necessarily, the fibers comprising the fiberboard are randomly configured and bound together with a suitable resin.

The term “cardboard” generally refers to a paper-based fiberboard or a product produced from a paper-based fiberboard, such as “Corrugated Cardboard”. “Corrugated Cardboard” refers to a cardboard comprising a plurality of generally thin planar or cardboard sheets, also known as “Linerboard”, that sandwich and are attached to undulating (or arched) layers of cardboard.

As used herein, the term “Non-Abrasive” refers to a material property wherein the material possessing this property substantially does not mar or scratch the surface or the finish of a typical door whether made of wood or another material. In some variations and embodiments, linerboard and consequently corrugated cardboard can be made that has a surface, even a single surface, that possesses Non-Abrasive characteristics.

Perforations, “Die Cuts”, and “Knifes” refer to partial or complete machined cuts or tears in a material that may or may not extend through the entire thickness of an associated material.

The term “Knockouts” as used herein refers to portions of a panel or sheet that have been removed to create desirable features such as handles or access points.

### A FIRST EMBODIMENT OF A SET OF EDGE PROTECTORS

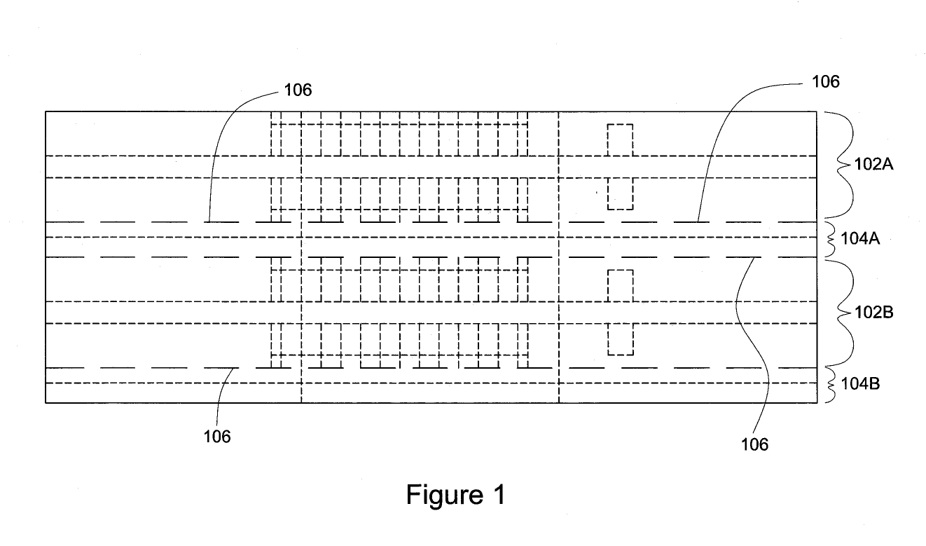

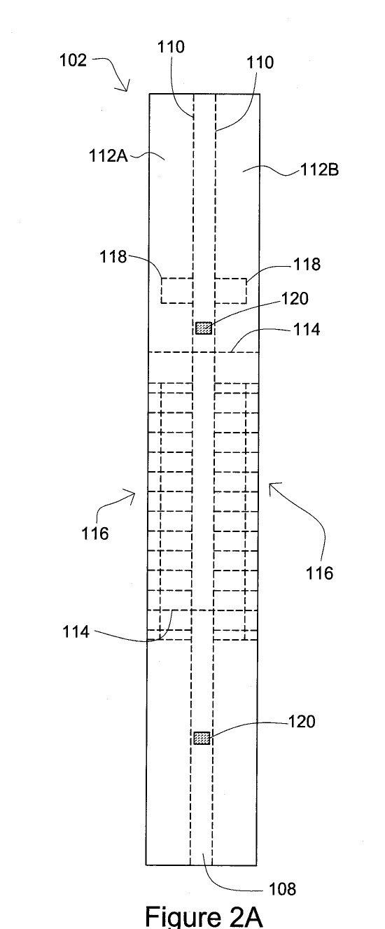

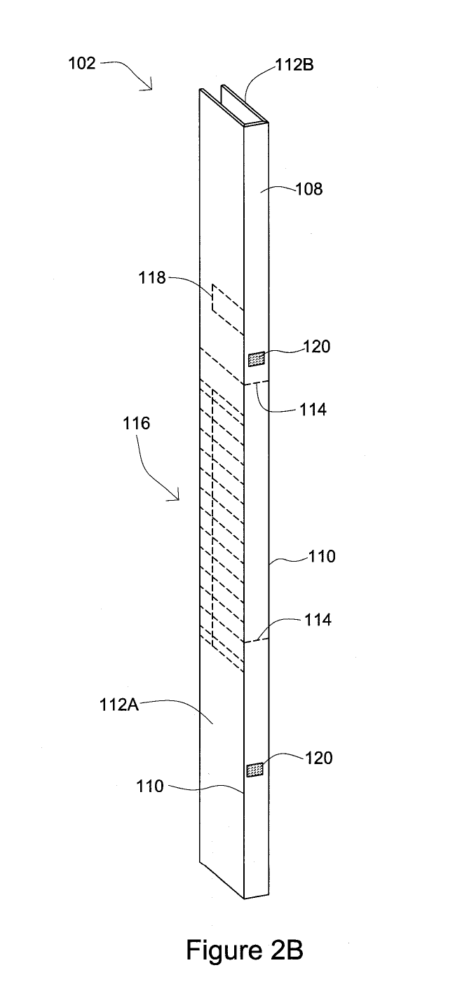

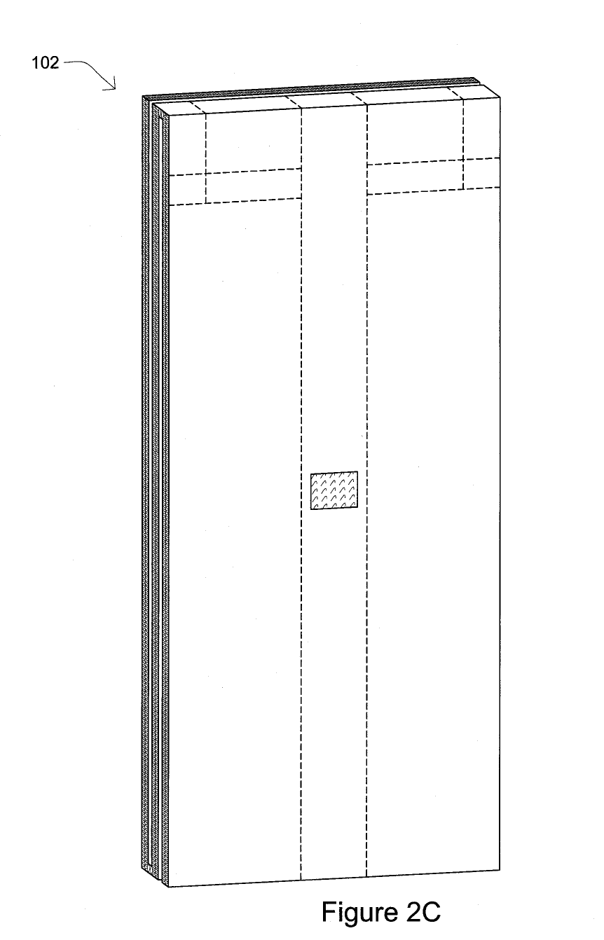

Referring to FIGS. 1, 2A-C, 3A-C, 5 & 6A-B, a set (or pair) of edge protectors are illustrated separately and/or together.

FIG. 1 illustrates two pairs of edge protectors 102a & 104a and 102b & 104b just after formation as they appear on a single 30″ by 78.5″ sheet of corrugated cardboard. As dictated by the configuration and features of the edge protectors a cylindrical die is pressed onto a suitable sheet of cardboard and imprints various knifes and die cuts into the board that both forms the various salient features of the edge protectors and form the necessary lines of perforations 106 that facilitate separation of the sets and of the individual protectors. As can be appreciated, fabricating as many edge protectors simultaneously on a single sheet increases manufacturing efficiency as well as reduces cardboard waste thereby ultimately reducing the cost to produce a set of edge protectors.

As mentioned, corrugated cardboard is typically used to produce the respective edge protectors that comprise a set. Generally, the corrugated cardboard is substantially similar to the cardboard utilized in the door protective cover described in patent applications referenced above. Specifically, the cardboard typically comprises: a paper front linerboard: a first corrugated paper layer that is bonded to the backside to the front linerboard; a paper center linerboard that is bonded on one side to the first corrugated paper layer; a second corrugated paper layer that is bonded to the other side of the center linerboard; and a paper rear linerboard that is bonded on its backside to the second corrugated paper layer. Effectively, the double corrugated layers act to absorb the energy of most incidental impacts with the edge protector thereby reducing the risk of damage to the underlying edges of an associated door.

The exterior or outer surface of the rear linerboard of the cardboard is often the surface that will come into direct contact with the surfaces of a door when installed thereon. As described in detail in the above referenced Door Protective Cover patent application, the exposed paper fibers and other particles that exist within a typical linerboard can, depending on the door's finish, cause fine scratches to be formed in the door when installed thereon. To minimize the risk of scratching, the rear linerboard, which ultimately comes in contact with the door surface, may be comprised of a material that has had its exterior surface coated with an abrasion resistant material, such as but not limited to NoMar™ manufactured by Michelman, Inc. of Cincinnati, Ohio. The non-abrasive coating effectively encapsulates and isolates potentially abrasive fibers of the cardboard from being in direct contact with the associated door.

While certain variations of the edge protectors are fabricated from cardboard sheets having two layers of corrugation, other variations are contemplated that utilize three or more layers of corrugation to provide additional impact protection. Similarly, variations utilizing a cardboard only having a single layer of corrugation are contemplated. Also, very thin variations may also be produced from a single non-corrugated piece of cardboard or fiberboard that wouldn't offer much in the way of impact protection but would help prevent scratching or other damage caused from incidental contact. In other embodiments, the edge protectors can even be fabricated from a Polyethylene foam sheet material such as is described in greater detail in the incorporated Door Protective Cover patent application.

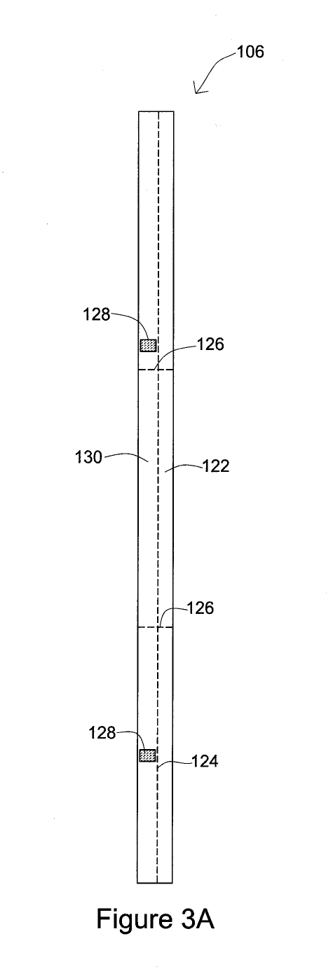

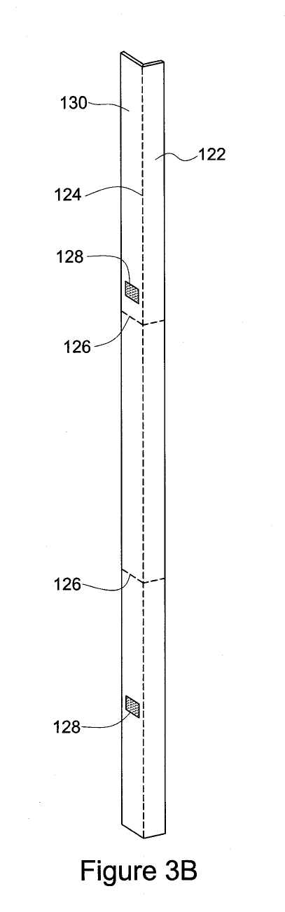

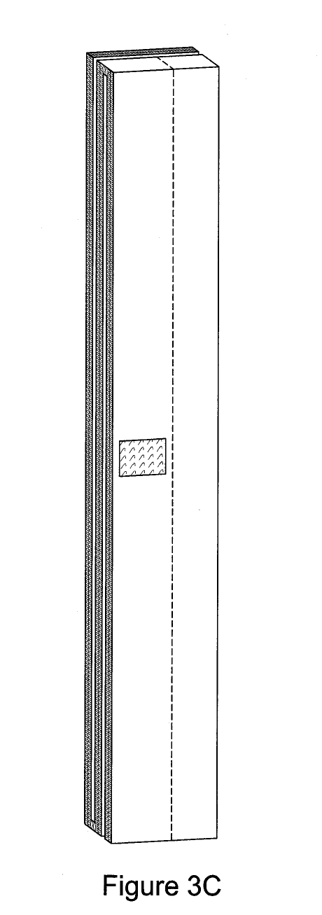

Two different edge protectors comprise a set: a strike side edge protector 102 as specifically illustrated in FIGS. 2A-C; and a hinge side edge protector 106 as specifically illustrated in FIGS. 3A-C. The strike side edge protector is used to cover and protect the vertically extending edge of a door wherein the latch or striker is located. Conversely, the hinge side edge protector is used to cover the vertically extending edge of a door wherein the door hinges are located to attach a door to an associated door frame. Each door protector is described separately below.

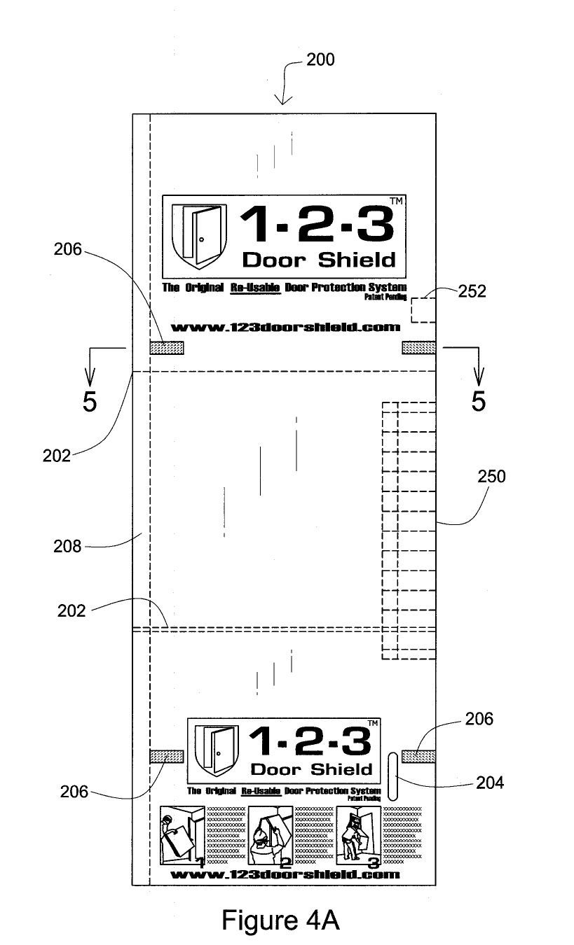

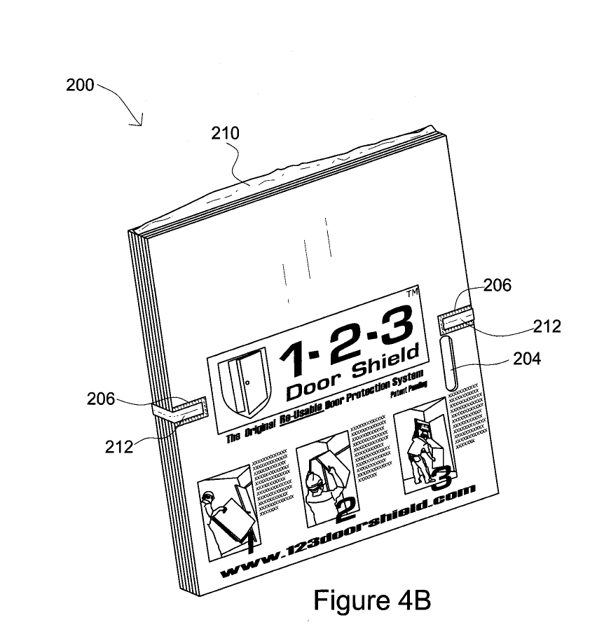

Referring primarily to FIG. 2A, the strike side edge protector 102 includes three distinct vertically extending sections. The center section 108 as bounded on either side by vertically-extending fold lines 110 is adapted to cover the exposed strike side vertically-extending edge of the door. Left and right sections 112A&B flank the center section along the fold lines and are adapted to slide underneath the corresponding panels of an associated door protective cover 200 (for example see FIGS. 4A&B) and fit flush against the front or back side surface of the door. Two widthwise fold lines 114 extend horizontally across the three sections at locations about one third the length from the respective widthwise ends of the protector. These fold lines permit the protector to be folded to one third its nominal length for purposes of storage, packaging and/or transport. FIG. 2C is an illustration of the strike side door protector in its folded configuration.

A plurality of perforations formed as nicks, knifes and other diecuts during the aforementioned fabrication phase are provided in door access regions 116 on both the left and right side sections 112A&B as illustrated in FIGS. 2A & 2B. These door access regions correspond substantially to the door access region of a corresponding door protective cover 200 as illustrated in FIGS. 4A&B. In a manner similar to that described in the Door Protective Cover patent application, the door hardware access region 116 facilitates the complete or partial removal of sections of cardboard in the region to facilitate access to any door hardware, such as door knob pulls or lever handles, as well as permit the remainder of the protector and the door protective cover to rest flush against the corresponding door. As can be appreciated, the door access region of the strike side edge protector is configured dimensionally to align with a corresponding door access region in the associated door protective cover.

Each door access region 116 includes a plurality of horizontal lines of perforations that extend from one vertical fold line bounding the center section to the vertical edge of the edge protector. In one variation, 14 horizontal lines are provided with each evenly spaced relative to the other associated lines, typically (but not necessarily) about 2 inches apart. As indicated above, the horizontal lines of perforations tend to align with similarly disposed horizontal lines on an associated door protector as described in the patent applications incorporated herein by reference.

Approximately 2″ from the vertical edges of each of the left and right side sections 112A&B in the door access region 116 as shown in FIG. 2A, a vertical line of perforations extends parallel to the vertical fold line between the topmost and the bottommost horizontal lines of perforations. This line corresponds with a similar vertical line of perforations found on the associated door protector 200.

Also included in typical variations of the edge protector on each of the side sections are three lines of perforations that form a rectangular knock out section 118 in combination with an adjacent portion of the associated vertical fold line. The rectangular knock out section is located above the door access region, typically about 8-10″, and can be removed when the door that is being covered/protected has a security latch, chain or bar mounted thereto in this location. It is appreciated that the associated door protector has a similar rectangular knock out section such that the rectangular knock out sections of the door protector substantially align with the rectangular knock out sections of the strike side edge protector.

It is appreciated that when the strike side edge protector 102 is installed, the associated edge of the door is completely covered including any bolts or strikers by the strike side edge protector's center section thereby inhibiting the ability to have the door latch or lock in an associated door frame when the door is closed. Further, depending on the thickness of the strike side edge protector the door may not even be able to fully close within the frame. Accordingly, the intended purpose of the knock out sections, such as the door access regions 116 is not to permit access to the underlying door hardware to permit functional use thereof but rather to ensure the remainder of the strike side edge protector and the overlaid door protector 200 lay substantially flat against the front and back surfaces of the door. If no knock out regions were provided the underlying door hardware would push the protectors outwardly and hinder their proper use and fit on the associated door.

Referring to FIGS. 2A&B, one or more small pieces 120 of hook or loop material are adhesively or otherwise secured to the outside surface of the center section of the strike side edge protector 102 at distinct locations that correspond to the locations of hook and loop strips and straps of an associated door protector 200. In one variation, the piece of hook and loop material comprises a rectangular piece of hook material that is corresponds to a loop material strap 212 on the associated door protector. During installation, the strike side edge protector is placed over a door with the left and right side sections being placed underneath the associated door protector. Next, the one or more loop material straps located on one or both panels of the door protector are pulled over the center section and secured to a corresponding hook strips on the other door protector panel. The loop material straps are also secured with the hook material pieces 120 of the strike side edge protector center section 108. Accordingly, the strike side edge protector 102 is secured in place.

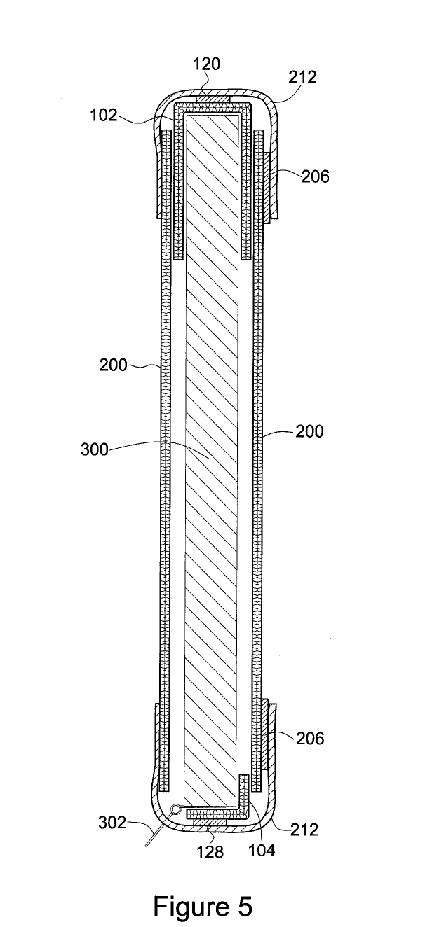

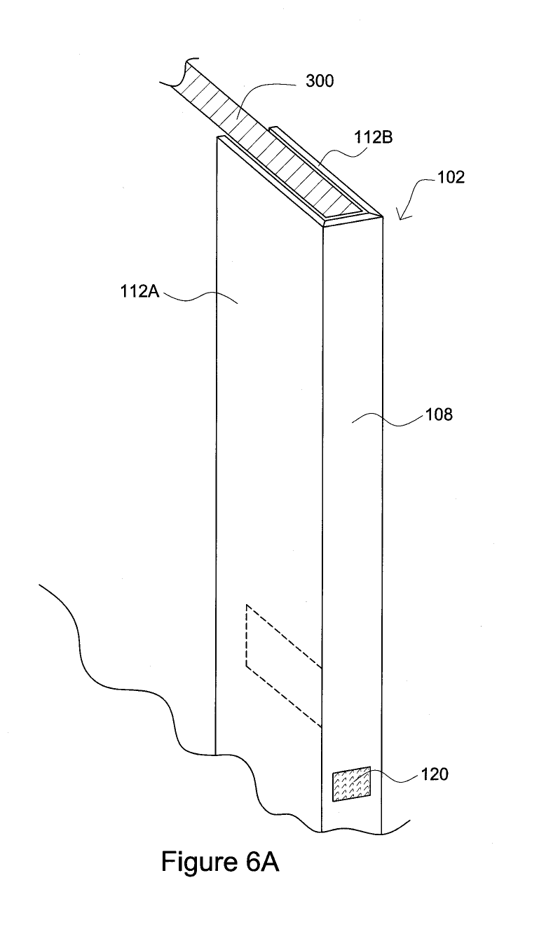

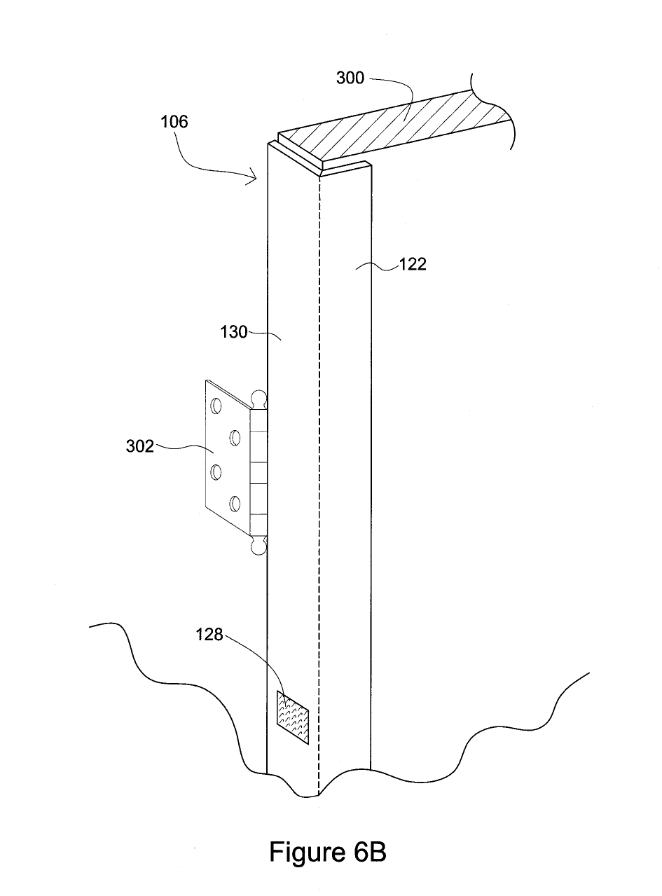

FIG. 2B illustrates the strike side edge protector 102 folded along the vertical fold lines 110 and FIG. 6A illustrates how the strike side edge protector interfaces with the strike side edge of an associated door 300. FIG. 5 is a cross sectional view illustrating the strike side door protector 102 installed on a door along with an associated door protector 200 and a corresponding hinge side edge protector 104.

A variation of the strike side edge protector is contemplated wherein the top portion of the protector includes a pair of horizontally extending die cut lines of perforations (not illustrated) that permit the overall length of the edge protector to be adjusted for use on doors of different lengths. A first line of horizontal perforations extends across the protector approximately 12″ vertically below the topmost edge of the protector, and a second line of perforations is parallel to the first line and located about 4″ vertically there below. Effectively the lines of perforations create horizontal sizing strips. In one configuration, when all strips are in place the length of the strike side edge protector is about 8 feet to fully cover the strike side edge of eight foot tall doors. When the horizontal sizing strip above the first line is removed the height of the protector is reduced to about 7 feet to cover the strike side edge of 7 foot doors. Finally when both sizing strips are removed by tearing them off at the second line, the size of the protector is reduced to 6 foot 8 inches to protect the edge of similarly sized doors. Accordingly, through the use of horizontal sizing strips only a single size of strike side edge protectors needs to be manufactured rather than a different protector for each of the aforementioned common door sizes. It is to be appreciated that similar horizontal sizing strips may be provided for in the hinge side edge protector as well.

Referring to FIGS. 3A-C, a typical hinge side edge protector 106 is illustrated. The hinge side edge protector comprises two distinct vertically extending sections: (i) a protective section 130 configured to substantially cover the hinge-side edge of the door; and (ii) a single flanking section 122 that is coupled to the protective section by way of a vertically extending fold line 124. The flanking section is adapted to slide underneath a corresponding panel of an associated door protective cover 200 (for example, see FIGS. 4A&B) and fits flush against the corresponding surface (typically the front surface) of the door. Two widthwise fold lines 126 extend horizontally across the two sections at locations about one third the overall length from the respective widthwise ends of the protector. These fold lines permit the protector to be folded to one third its nominal length for purposes of storage, packaging and/or transport. FIG. 3C is an illustration of the hinge side edge protector in its folded configuration.

Since the surfaces of a typical interior door do not have any hardware protruding therefrom proximate the hinge side edge, horizontal and vertical lines of perforations forming knock out or fold way sections are typically not required or provided on the flanking section 122 (see FIG. 3A). It is to be appreciated, however, that as required lines of perforations can be provided in variations. Further, the width of the flanking section of the hinge side edge protector 106 is typically much narrower than the left and right sections 112A&B (See FIGS. 2A&B) of the strike side edge protector 102. In one variation the width of the flanking section is about 1.5-2.0 inches although the width is not considered particularly critical and can vary.

Similar to the center section of the strike side edge protector and as shown in FIGS. 3A&B, the protective section 130 of the hinge side protector includes one or more small pieces 128 of hook or loop material that are adhesively or otherwise secured to the outside surface thereof at distinct locations that correspond to the locations of hook and loop strips 206 and straps 212 of the associated door protector 200 (See FIGS. 4A&B and 5). In one variation, the piece of hook and loop material comprises a rectangular or circular piece of hook material that is corresponds to a loop material strap on the associated door protector. During installation, the hinge side edge protector is placed over a door with the flanking section being placed underneath the associated door protector. Next, the one or more loop material straps located on one or both panels of the door protector are pulled over the protector section and secured to a corresponding hook strips on the other door protector panel. The hoop material of the straps also secure themselves to the hook material pieces of the hinge side edge protector protective section. Accordingly, the hinge side edge protector is secured in place.

FIG. 3B illustrates the hinge side edge protector 106 folded along the vertical fold line 124 and FIG. 6B illustrates how the hinge side edge protector interfaces with the hinge side edge of an associated door 300.

### A SECOND EMBODIMENT OF A SET OF EDGE PROTECTORS

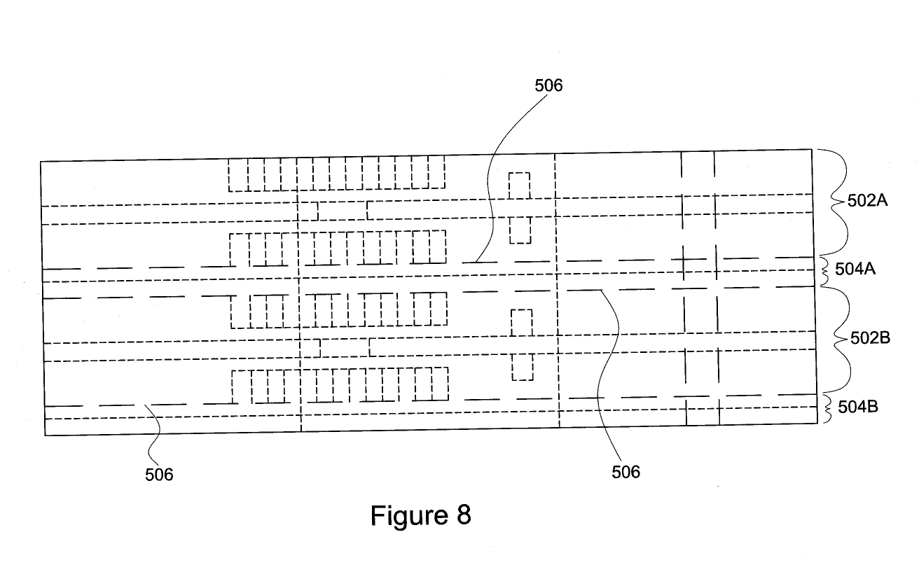

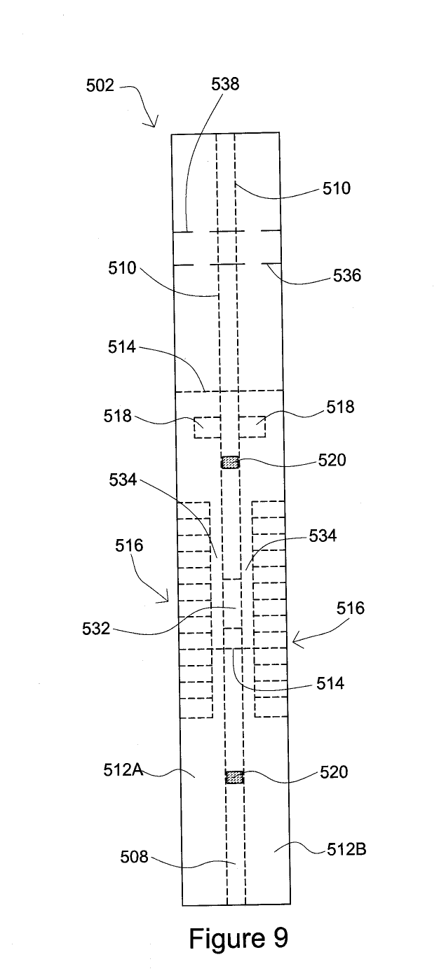

FIG. 9 illustrates another embodiment of a strike side edge protector that differs in several details from the embodiment described above. FIG. 8 illustrates two pairs of edge protectors 502a & 504a and 502b & 504b just after formation as they appear on a single sheet of corrugated cardboard. This embodiment is formed on the cardboard in a similar manner as described above including forming of lines of perforations 506 that facilitate separation of the sets and of the individual protectors.

The hinge side edge protectors 504 in the second embodiment are nearly the same as the hinge side edge protectors of the first embodiment, and accordingly, need not be described in significant detail herein with respect to the second embodiment.

The second embodiment strike side edge protector 502 is generally similar to the first embodiment edge side protector 504. For instance, the second embodiment protector is divided into three distinct vertically extending sections: the center section 508 as bounded on either side by vertically-extending fold lines 510 is adapted to cover the exposed strike side vertically-extending edge of the door. Left and right sections 512A&B flank the center section along the fold lines and are adapted to slide underneath the corresponding panels of an associated door protective cover 200 (for example see FIGS. 4A&B) and fit flush against the front or back side surface of the door. Two widthwise fold lines 514 extend horizontally across the three sections at locations about one third the length from the respective widthwise ends of the protector. These fold lines permit the protector to be folded to one third its nominal length for purposes of storage, packaging and/or transport. The second embodiment folds in a manner similar to the First embodiment as illustrated in FIG. 2C.

The second embodiment also include rectangular knock out sections 518 that can be removed when the door that is being covered/protected has a security latch, chain or bar mounted thereto in this location. Further, one or more small pieces 520 of hook or loop material are adhesively or otherwise secured to the outside surface of the center section of the strike side edge protector 502 at distinct locations that correspond to the locations of hook and loop strips and straps of an associated door protector 200.

The second embodiment strike side edge protector 502 also includes left and right door access regions 516 comprising a plurality of lines of perforations. As with the first embodiment strike side edge protector, these door access regions correspond substantially to the door access region of a corresponding door protective cover 200 as illustrated in FIGS. 4A&B. Unlike the first embodiment, the horizontal line of perforations of the door access regions of the second embodiment do not extend completely across the respective left and right side sections 512A&B. In contrast, the horizontal lines terminate at a vertical line of perforations that is generally parallel with but spaced about an inch or so away from a respective vertically-extending fold line 510. Accordingly, removing a rectangular portion of the door access region of a particular left or right side sections does not effectively separate the side section into top and bottom portions as in the first embodiment: instead the portions of the side section above and below the removed portion remained connected by the strip 534 located between the vertically-extending fold line and the door access region's vertical line of perforations.

Another difference between the first embodiment strike side protector and the second is the inclusion of a rectangular striker knock out portion 532 in the center section located at a location that corresponds with the typical location of a door latch or striker on a door. Accordingly, the spring loaded striker does not have a tendency to push or bias the edge protector outwardly away from a flush position against an associated door's edge. It is to be appreciated that providing such a knock out in the first embodiment could result in the door protector being divided into two distinct pieces if the striker knockout is removed along with adjacent portions of the rectangular knockout portions of the door access regions 516. The aforementioned vertical strips 534 of the second embodiment prevent such a separation from occurring.

A set of one or more widthwise lines of perforations 536 & 538 are provided that extend fully across the strike side edge protector. These lines of perforations permit a user to tear off a portion of the edge protector to resize it for shorter door. In one variation, the edge protector is initially sized for an eight foot door. By tearing off a top portion above the topmost widthwise line of perforations 538, the length of the edge protector is reduced to seven feet for seven foot tall doors. By removing the portion above the lower widthwise line of perforations 536, the length of the edge protector is reduced to six feet eight inches for similarly sized doors. A similar feature can be incorporated into variations of the first embodiment edge protector as well as is described in detail above. Similarly, the widthwise lines of perforation can also be provided on the hinge side edge protectors of either embodiment to save the same purpose as on the strike side edge protectors.

### AN EMBODIMENT OF A DOOR PROTECTOR FOR USE WITH THE SET OF EDGE PROTECTORS

Referring to FIGS. 4A&B, one embodiment door protector 200 is illustrated that can be used either alone as described in U.S. patent application Ser. No. ______ (incorporated by reference above) or in combination with one or both edge protectors 102 & 106 of the set. The door protector described herein below is merely illustrative. It and other embodiments and variations are described in the above referenced patent applications. It is to be appreciated that other door protector embodiments can either be used with the embodiment of the edge protector described herein or other variations and embodiments of an edge protector.

The door protector typically comprises front and rear panels similar to the panel illustrated in FIG. 4A. The panel is typically but not necessarily comprised of a corrugated cardboard material similar to the cardboard material of which the set of edge protectors are fabricated. Each panel's back linerboard may in some variations be coated with abrasion resistant coating such as Nomar™ to minimize any fine scratching of the door that could be caused by a protective cover. The panels are generally sized to cover a particular size door nearly completely except for a 0.5-1.0″ section on each door proximate the door's vertical edges so that the door can be closed in an associated door frame without having to remove the door protector, although in some variations a tear off strip 208 may be provided along one or both edges to permit a single size panel to be used in either a wider or more narrow door. Incidentally, these uncovered portions on the faces of a door covered with the door protector are typically covered by the left and right sections of the strike side edge protector and the flanking section of the hinge side edge protector when the edge protectors are installed thereon.

As illustrated, a door hardware cutout section 250 comprising a plurality of vertical and horizontal lines of perforations is provided in each panel that effectively matches up with similar lines of perforations on the strike side edge protector 102 as described above. Additionally, a knock out 252 may be provided for a security latch as also discussed above. Each panel also typically includes a plurality of horizontally extending fold lines 202 that permit the panel to be folded, such as in halves, in thirds or quarters, for storage and transport. Handle knockouts 204 may also be provided to facilitate transport of the protector as well as hoisting it up onto a door.

Hook and loop straps 212 that are each typically adhesively affixed to one cardboard sheet proximate a vertical edge thereof are typically provided. Correspondingly, a strip of hook and loop material 206 is affixed proximate a corresponding vertical edge of the associated opposing cardboard sheet for each strap. The straps serve several purposes: (1) to hold the door protector 200 against a door when in the deployed configuration; (2) to retain the door protector in its folded configuration when it is not being used (see FIG. 4B); and (3) to hold the edge protectors 102 & 106 in place.

Front and back panels are typically joined together along a top edge by way of a piece of polymeric sheet material 210 (also referred to as saddle tape herein) that is relatively thin so that it does not interfere with opening and closing the door within the top edge of the door frame. As illustrated in FIG. 4B, a single piece that extends across substantially the entire width of each panel is illustrated but in other variations multiple strips of sheet material can be used. The sheet material is typically although not necessarily adhered to the respective panels with adhesive, such as a contact adhesive.

### A Method of Protecting a Door Installed in a Doorway

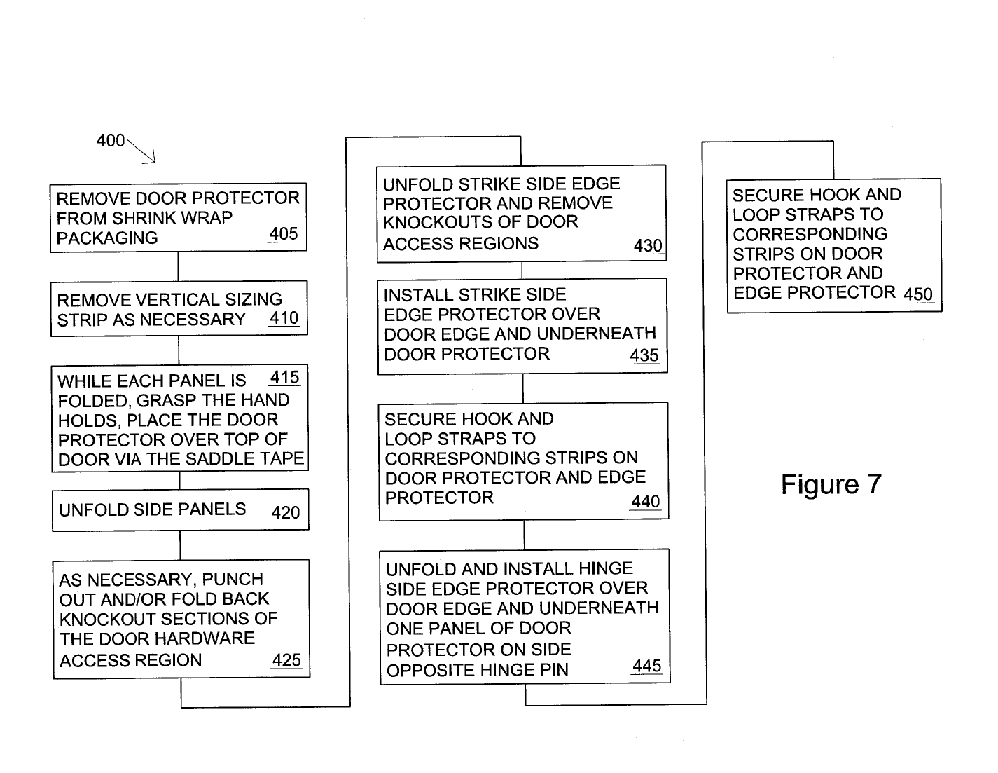

FIG. 7 is a block diagram 400 illustrating the methodology of installing a door protector and associated set of edge protectors on a door 300 that is hanging in a doorway. It is appreciated, however, that a similar methodology can be utilized to install other embodiment door protectors on a door that has not been previously installed in a doorway.

When the door protector and the set of edge protectors are used initially, they are removed from its packaging as indicated in block 405. Some variations are shrink-wrapped in their folded configurations. Other variations of the door protector may or may not be wholly or partially enclosed in packaging as the hook and loop straps adhered to the protector effectively hold the unit in its compact folded configuration for shipping and storage. While the edge protector may be sold as an added cost option when purchasing a door protector, combinations of the door and edge protectors may be provided together in a single package.

If the door protector 200 includes a vertical sizing strip 208 and the door which is to be covered is narrower than the door protector, the user can remove the vertical sizing strip or strip(s) as necessary as indicated in block 410 by tearing it off along the provided and associated line(s) of perforations to reduce the width of the protector to be either essentially the same width as the door or more often less wide than the door by about 0.5-1.0″. In variations in which the sizing feature is not provided the user selects a door protector model having a suitable width relative to the width of the door.

Next, as indicated in block 415, the user typically lifts the door protector 200 with the panels folded often using the provided handle knockouts 204 upwardly sliding the saddle tape 210 over the top edge of the associated door. The protector's panels are centered on the door.

The user typically unstraps the hook and loop straps 212 and unfolds the panels such that the panels cover substantially the entire surface of the door as indicated in block 420. This operation may be done either before or after the saddle tape is slide over the door's top edge. It is appreciated that the protector's folded configuration as shown for instance in FIG. 4B facilitates the unfolding of the panels in such a manner that only the non-abrasive inside surfaces of the panels are in contact with the exterior face surfaces of the door.

As necessary and as indicated in block 425, various sections of the door hardware access region are folded back, punched out or removed to permit access to the door's hardware, such as locks and door handles and to permit the panels to rest flush against the respective front and back side of the door. The user may at his/her option remove the necessary sections. Further, if the protector is being reused, some or all of the sections in the door hardware access region may have already been removed.

Based on the portions of the door hardware access region that are removed from the door panels of the door protector, similar portions are removed from the door hardware access regions of the left and right sides 112A&B of the strike side edge protector 102 as well as the latch knockout as is appropriate as indicated in block 430. The left and right side sections of the strike side edge protector are then slid underneath the respective front and back panels of the door protector 200 as indicated in block 435. Once the strike side edge protector has been installed, the user typically secures the loop straps 212 on the strike side of the door protector to the corresponding hook strips 120 on the strike side of the door protector as well as the correspondingly located strips 206 on the strike side edge protector to secure the door panels and the strike side edge protector in place as indicated in block 440. FIG. 5 is cross sectional view of a door having a door protector and a set of edge protectors installed thereon.

The hinge side edge protector 106 is butted up against the door hinges 302 and the flanking section is slid under the proximate door protector panel as indicated in block 445 and as also shown in FIG. 5. Finally, once the hinge side edge protector has been installed, the user typically secures the hook and loop straps 212 on the hinge of a panel of the door protector to the corresponding hook strips 206 on the hinge side of the other panel of the door protector as well as the correspondingly located strips 128 on the hinge side edge protector to secure the door panels and the hinge side edge protector in place as indicated in block 450.

After installing the door protector the door is effectively protected against light to moderate impacts that might occur during construction in the surrounding interior space and/or moving furniture and other items through the doorway. When the associated construction, moving or other work has been completed the door protector is removed from the door by essentially reversing the process described above. The folded door protector and the folded edge protectors can be conveniently stored for future use.

Of important note, the protected door cannot typically be fully closed and locked when the edge protectors are installed as the thickness of the protectors will often prevent the door from fitting into the associated door frame. Furthermore, the strike side edge protector typically covers the latch hardware. However, if a user desires to lock a door, he or she can typically remove the edge protectors without removing the door protector itself to gain full functionality of the door while retaining front and rear protection as provided by the door protector. It is appreciated that when the door is closed the edges of the door are typically fully protected by the door frame. The user can reinstall the edge protectors as need to provide the desired protection to the door when it is reopened.

### ALTERNATIVE EMBODIMENTS AND OTHER VARIATIONS

The various embodiments and variations thereof illustrated in the accompanying Figures and/or described above are merely exemplary and are not meant to limit the scope of the invention. It is to be appreciated that numerous variations of the invention have been contemplated as would be obvious to one of ordinary skill in the art with the benefit of this disclosure. For instance, the edge protectors make use of corrugated cardboard as its primary material. It is to be appreciated that variations can make use of other suitable materials such as but not limited to: (i) foam board; (ii) corrugated plastic sheet material; (iii) cardboard or plastic sheet material having a honeycomb type core; and (iv) a fiberboard.

We claim:

1. A door edge protective cover adapted to substantially cover a strike side edge of a door, the door edge protective cover comprising:
a generally rectangular elongated first edge panel comprising a sheet material having left and right lengthwise edges and top and bottom widthwise edges, the first edge panel including,
spaced apart left and right lengthwise fold lines each extending from the top widthwise edge to the bottom widthwise edge, the left fold line being substantially parallel to the right fold line and the lengthwise edges,
a left side section bounded by the left lengthwise edge, the top and bottom edges and the left lengthwise fold line,
a right side section bounded by the right lengthwise edge, the top and bottom edges and the right lengthwise fold line,
a center section bounded by the left and right lengthwise fold lines and the top and bottom edges, a width of the center section being generally 1.0-3.0 inches, and
one or more widthwise extending fold lines facilitating the folding of the door edge protective cover to a folded length no greater than ½ an unfolded length.

2. The door edge protective cover of claim 1, further including one or more fasteners distributed and secured to an outside surface of the center section.

3. The door edge protective cover of claim 2 wherein the one or more fasteners comprise one of a piece of hook material or a piece of loop material.

4. The door edge protective cover of claim 1, wherein each of the left and right side sections include a door access region, the door access region comprising a plurality of widthwise lines of perforations extending from one of the left and right lengthwise edges to one of the left and right lengthwise fold lines, a bottom edge of the door access region being located about 24-36″ above the bottom widthwise edge, the lines of perforations forming removable generally rectangular sections.

5. The door edge protective cover of claim 4, wherein the plurality of widthwise lines of perforations comprises at least 10 spaced apart lines of perforations.

6. The door edge protective cover of claim 5, wherein the door access regions each further include one or more vertical lines of perforations extending between a topmost widthwise line of perforations and bottommost widthwise line of perforations.

7. The door edge protective cover of claim 5, wherein the first edge panel comprises corrugated cardboard.

8. The door edge protective cover of claim 7, wherein an outer surface of an exterior sheet of linerboard includes an abrasion resistant coating.

9. The door edge protective cover of claim 8, wherein the abrasion resistant coating comprises NoMar™.

10. A combination of the door edge protective cover of claim 1 and a second door edge protective cover adapted to cover a hinge side edge of the door, the second door edge protective cover comprising:
a generally rectangular elongated second edge panel comprising the sheet material having a left and right lengthwise edges and top and bottom widthwise edges, the second edge panel including,
a lengthwise fold lines extending from the top widthwise edge to the bottom widthwise edge, the fold line being substantially parallel to the lengthwise edges,
a left side section bounded by the left lengthwise edge, the top and bottom edges and the lengthwise fold line, and
a right side section bounded by the right lengthwise edge, the top and bottom edges and the lengthwise fold line, a width of the right side section being generally 1.0-3.0 inches, and
one or more widthwise extending fold lines facilitating the folding of the second door edge protective cover to a folded length no greater than ½ an unfolded length.

11. The combination of claim 10 wherein the second door edge protective cover further includes one or more fasteners distributed and secured to an outside surface of the right side section.

12. The combination of claim 11 wherein the one or more fasteners of the second door edge protective cover comprise one of a piece of hook material or a piece of loop material.

13. The combination of claim 10 wherein the sheet material comprises corrugated cardboard.

14. A system for protecting a door installed in a doorway, the system comprising:
(i) a door protective cover including,
a front panel at least partially comprising a corrugated cardboard material, the front panel having two or more widthwise front panel folds extending substantially from a first front panel lengthwise edge to an opposing second front panel lengthwise edge;
a back panel at least partially comprising the corrugated cardboard material, the back panel having two or more widthwise back panel folds extending substantially from a first back panel lengthwise edge to an opposing second back panel lengthwise edge; and
a one or more saddle elements, the saddle elements being adapted to couple the front and rear panels together proximate a first front panel widthwise edge and a first back panel widthwise edge;
wherein the protective door cover is adapted to fold to a storage/shipping configuration having a length corresponding to the aforementioned lengthwise edges of the front and back panels that is about 33% or less than the length of the lengthwise edges;
(ii) a strike side door edge protective cover including,
a generally rectangular elongated first edge panel comprising the corrugated cardboard material having a left and right lengthwise edges and top and bottom widthwise edges, the first edge panel including,
spaced apart left and right lengthwise fold lines each extending from the top widthwise edge to the bottom widthwise edge, the left fold line being substantially parallel to the right fold line and the lengthwise edges,
a left side section bounded by the left lengthwise edge, the top and bottom edges and the left lengthwise fold line,
a right side section bounded by the right lengthwise edge, the top and bottom edges and the right lengthwise fold line,
a center section bounded by the left and right lengthwise fold lines and the top and bottom edges, a width of the center section being generally 1.0-3.0 inches, and
one or more widthwise extending fold lines facilitating the folding of the strike side door edge protective cover to a folded length of about ⅓ an unfolded length or less; and
(iii) a hinge side door edge protective cover including
a generally rectangular elongated second edge panel comprising the corrugated cardboard material having a left and right lengthwise edges and top and bottom widthwise edges, the second piece including,
a lengthwise fold lines extending from the top widthwise edge to the bottom widthwise edge, the fold line being substantially parallel to the lengthwise edges,
a right side section bounded by the left lengthwise edge, the top and bottom edges and the lengthwise fold line, and
a left side section bounded by the right lengthwise edge, the top and bottom edges and the lengthwise fold line, a width of the right side section being generally 1.0-3.0 inches, and
two or more widthwise extending fold lines facilitating the folding of the hinge side door edge protective cover to a folded length of about ⅓ an unfolded length or less.

15. The system of claim 14, further comprising:
(i) a plurality of elongated straps fixedly secured to one or both of the front and back panels proximate each respective panel's lengthwise edges, the straps being comprised of one of hook material or loop material; (ii) a first plurality of strips fixedly secured to one or both the front and back panels proximate each respective panel's lengthwise edges at locations corresponding to locations of elongated straps on the other panel, the strips being comprised of the other of hook material and loop material, each strip of the first plurality being adapted to removably secure a corresponding strap thereto; and (iii) a second plurality of strips fixedly secured to a center section of the strike side door edge protective cover and a left side section of the hinge side door edge protective cover, each strip of the second plurality being adapted to removably secure a corresponding strap thereto.

16. The system of claim 15, wherein each of the left and right side sections of the strike side door edge protective cover further comprise a door access region, the door access region comprising a plurality of widthwise lines of perforations extending from one of the left and right lengthwise edges to one of the left and right lengthwise fold lines, a bottom edge of the door access region being located about 24-36″ above the bottom widthwise edge, the lines of perforations forming removable generally rectangular sections.

17. A method comprising:
providing a door protector in a folded configuration wherein the width of the door protector in the folded configuration is approximate the width of a typical door, the door protector is adapted to cover and the height of the folded door protector is about ½ or less the height of the typical door, the door protector comprising (i) a front panel at least partially comprising a corrugated cardboard material, the front panel having one or more widthwise front panel folds extending substantially from a first front panel lengthwise edge to an opposing second front panel lengthwise edge, (ii) a back panel at least partially comprising a corrugated cardboard material, the back panel having one or more widthwise back panel folds extending substantially from a first back panel lengthwise edge to an opposing second back panel lengthwise edge, (iii) a one or more saddle elements, the saddle elements being adapted to couple the front and rear panels together proximate a first front panel widthwise edge and a first back panel widthwise edge wherein the protective door cover is adapted to fold to a storage/shipping configuration having a length corresponding to the aforementioned lengthwise edges of the front and back panels that is about 50% or less than the length of the lengthwise edges, (iv) a plurality of elongated straps fixedly secured to one or both of the front and back panels proximate each respective panel's lengthwise edges, the straps being comprised of one of hook material or loop material, and (v) a plurality of strips fixedly secured to one or both the front and back panels proximate each respective panel's lengthwise edges at locations corresponding to locations of elongated straps on the other panel, the strips being comprised of the other of hook material and loop material, each strip being adapted to removably secure a corresponding strap thereto;
unfolding the door protector, wherein the door protector has a height proximate the height of the typical door in its unfolded configuration;
hanging the door protector over a top edge of the door by way of the one or more saddle elements;
installing a strike side edge protector over a strike side edge of the typical door, the strike side edge protector comprising a generally rectangular elongated first edge panel comprising the corrugated cardboard material having a left and right lengthwise edges and top and bottom widthwise edges, the first edge panel including,
spaced apart left and right lengthwise fold lines each extending from the top widthwise edge to the bottom widthwise edge, the left fold line being substantially parallel to the right fold line and the lengthwise edges,
a left side section bounded by the left lengthwise edge, the top and bottom edges and the left lengthwise fold line,
a right side section bounded by the right lengthwise edge, the top and bottom edges and the right lengthwise fold line,
a center section bounded by the left and right lengthwise fold lines and the top and bottom edges, a width of the center section being generally 1.0-3.0 inches, and
one or more widthwise extending fold lines facilitating the folding of the strike side door edge protective cover to a folded length of about ⅓ an unfolded length or less
installing a hinge side edge protector over a hinge side edge of the typical door, the hinge side edge protector comprising a generally rectangular elongated second edge panel comprising the corrugated cardboard material having a left and right lengthwise edges and top and bottom widthwise edges, the second piece including,
a lengthwise fold lines extending from the top widthwise edge to the bottom widthwise edge, the fold line being substantially parallel to the lengthwise edges,
a right side section bounded by the left lengthwise edge, the top and bottom edges and the lengthwise fold line, and
a left side section bounded by the right lengthwise edge, the top and bottom edges and the lengthwise fold line, a width of the right side section being generally 1.0-3.0 inches, and
two or more widthwise extending fold lines facilitating the folding of the hinge side door edge protective cover to a folded length of about ⅓ an unfolded length or less;
securing the front and back panels and the strike side and hinge side edge protectors together on the door along their lengthwise edges by way of the strips on the door protector, the strike side edge protector and the hinge side edge protector and straps of the door protector.

18. The method of claim 17, wherein the strips and the straps comprise hook material or loop material.

19. The method of claim 18, wherein said securing the front and back panels and the strike side and hinge side edge protectors together comprises extending at least one strap secured to one of the front and rear panels over and against both a strip on one of the strike side and hinge side edge protectors and a strip on the other of the front and back panels.

20. The method of claim 19: wherein the front and rear panels of the door protector and the strike side edge protector further include door access regions, the door access region on each comprising a plurality of widthwise lines of perforations extending from a respective lengthwise edge to a respective lengthwise line of perforations, the door access region being located about 24-36″ above a respective bottom widthwise edge, the lines of perforations forming removable generally rectangular sections; and wherein the method further comprises, removing one or more rectangular sections from the door access regions of the front panel, the rear panel and the strike side edge protector such that the one or more rectangular sections of each door access region are generally aligned with the other door access regions when the door protector and the strike side edge protector are installed on the typical door.
